(19) United States
(12) Patent Application Publication
(10) Pub. No.: US 2013/0141668 A1
(43) Pub. Date: Jun. 6, 2013

(54) DISPLAY DEVICE

(71) Applicants: Hajime Washio, Osaka-shi (JP); Shinsuke Yokonuma, Osaka-shi (JP)

(72) Inventors: Hajime Washio, Osaka-shi (JP); Shinsuke Yokonuma, Osaka-shi (JP)

(73) Assignee: SHARP KABUSHIKI KAISHA, Osaka-shi, Osaka (JP)

(21) Appl. No.: 13/816,583

(22) PCT Filed: May 20, 2011
(86) PCT No.: PCT/JP2011/061618

§ 371 Date: Feb. 12, 2013

(30) Foreign Application Priority Data
Aug. 18, 2010 (JP) 2010183283

(51) Int. Cl. G02F 1/1335

(52) U.S. Cl. CPC G02F 1/1335
USPC 349/62

(57) ABSTRACT

A display device with low power consumption having increased added value is provided.

There are provided a memory liquid crystal panel (10), a backlight (20), and a PET sheet (30). The memory liquid crystal panel (10) includes a plurality of pixel circuit parts (11) each having a reflecting electrode (12), a transmission electrode (13), and a memory circuit (14A). On the surface of the PET sheet (30), print patterns (32A to 32D) are formed by ink. In a transmission display mode, a region in which the print patterns (32A to 32D) are printed in the PET sheet (30) suppresses transmission of backlight light (Ps) and a region in which the print patterns are not printed transmits the backlight light (Ps) without suppressing light. In such a manner, a sub image (Sp) is additionally displayed in a main image (Mp).

### TECHNICAL FIELD

The present invention relates to a display device and, more particularly, to a display device in which a memory function is provided for each of pixels.

### BACKGROUND ART

Hitherto, a liquid crystal display device is requested to reduce its power consumption. Consequently, in recent years, a memory liquid crystal display device in which a memory function is provided for each of pixels is proposed. In the memory liquid crystal display device, generally, data of one bit can be stored in each pixel. When there is no change in a display image, data stored in a memory circuit is written to a pixel electrode. In a memory liquid crystal display device, once data is stored in the memory circuit, the data stored in the memory circuit is held until it is rewritten. Consequently, since no power for rewriting is needed in the case where there is no change in the display image, power consumption is largely reduced.

For example, a display device having a pixel memory circuit is disclosed as a memory liquid crystal display device (refer to Patent Document 1). In the display device, a pixel circuit capable of holding data of one bit is provided for each pixel unit made of three sub pixels of R, G, and B, not for each of sub pixels of R, G, and B. With the configuration, without deteriorating an aperture ratio, decrease in power consumption by memory driving can be realized.

In relation to the present invention, the following conventional technique is known. Specifically, Patent Document 2 discloses a semi-transmissive liquid crystal display device for displaying an image, a background color, and the like by a decoration layer only when a backlight is on by disposing a half mirror having the decoration layer formed on its rear surface between a liquid crystal display panel and the backlight. The semi-transmissive liquid crystal display device has a liquid crystal display panel, a backlight which emits light from the rear surface side of the liquid crystal display panel, and a half mirror disposed between the liquid crystal display panel and the backlight, transmitting light emitted from the backlight, and reflecting light incident from a front surface side of the liquid crystal display panel. On the rear surface of the half mirror, the decoration layer which is projected through the half mirror only when the backlight is on is formed by printing. Accordingly, when the backlight is on, by the decoration layer provided on the rear surface of the half mirror, an image, a background color, and the like formed by the decoration layer can be projected through the half mirror.

### PRIOR ART DOCUMENTS

### Patent Documents

[Patent Document 1] Japanese Patent Application Laid-Open No. 2007-286237
[Patent Document 2] Japanese Patent Application Laid-Open No. 2006-330658

### SUMMARY OF THE INVENTION

### Problems to be Solved by the Invention

A memory liquid crystal display device is a display device aiming at lower power consumption. Consequently, a total reflection type using no backlight which requires large power is a main display type of the memory liquid crystal display device. However, in a case of considering visibility in a dark place, it is desirable to provide a small transmission part in each of pixels and supplementarily perform transmissive display using the backlight as auxiliary lighting.

The memory liquid crystal display device is demanded to have increased added value in addition to the auxiliary transmissive display. For example, when an auxiliary image (a product logo, a branch name, or the like) can be displayed at the time of transmissive display in addition to an image to be originally displayed, improvement in design and merchantability can be realized.

Therefore, an object of the present invention is to provide a display device with low power consumption having increased added value.

### Means for Solving the Problems

A first aspect of the present invention provides a display device for performing display in a reflection display mode and a transmission display mode, which includes:

a first liquid crystal panel including a plurality of pixel circuit parts each having a reflector, a transmitter, and a memory circuit capable of holding at least 1-bit data;

a light source provided on a rear surface side of the first liquid crystal panel; and

a pattern display portion provided between the first liquid crystal panel and the light source and selectively suppressing transmission of light from the light source,

wherein in the reflection display mode, display is performed using light incident from a front surface side of the first liquid crystal panel and,

in the transmission display mode, display is performed using light of the light source incident from the rear surface side of the first liquid crystal panel.

A second aspect of the present invention provides the display device according to the first aspect of the present invention. In this device,

wherein in the first liquid crystal panel, the ratio of reflecting light incident from the front surface side of the first liquid crystal panel is higher than the ratio of transmitting light of the light source which is incident from the rear surface side of the first liquid crystal panel.

A third aspect of the present invention provides the display device according to the first or second aspect of the present invention. In this device,

wherein the pattern display portion is a transparent resin sheet on which a light suppression part for suppressing transmission of light is formed.

A fourth aspect of the present invention provides the display device according to the third aspect of the present invention. In this device,

wherein the light suppression part is formed by ink.

A fifth aspect of the present invention provides the display device according to the first or second aspect of the present invention. In this device,

wherein the pattern display portion is a second liquid crystal panel in which a light suppression part for suppressing transmission of light is formed according to an applied voltage.

A sixth aspect of the present invention provides the display device according to the fifth aspect of the present invention. In this device,

wherein the second liquid crystal panel is of a segment display type.

A seventh aspect of the present invention provides the display device according to the fifth aspect of the present invention. In this device,

wherein the second liquid crystal panel is of a dot matrix display type.

A eighth aspect of the present invention provides the display device according to the seventh aspect of the present invention. In this device,

wherein the second liquid crystal panel is of an active matrix drive type.

A ninth aspect of the present invention provides the display device according to the seventh aspect of the present invention. In this device,

wherein the second liquid crystal panel is of a simple matrix drive type.

A tenth aspect of the present invention provides the display device according to the seventh aspect of the present invention. In this device,

wherein the second liquid crystal panel is of a transmission type.

### Effects of the Invention

According to the first aspect of the present invention, since each pixel circuit part has the memory circuit, as long as there is no change in an image to be displayed, data write power is unnecessary, and alternating current driving can be performed at low frequency. Consequently, power consumption can be reduced. Display is performed in the reflection display mode using light incident from the front surface side of the first liquid crystal panel. In such a manner, power consumption can be further reduced. Further, in the transmission display mode using light of the light source which is incident from the rear surface side of the first liquid crystal panel, an image is displayed through the pattern display portion. Thus, it can increase the added value.

According to the second aspect of the present invention, the reflectance of the first liquid crystal panel is higher than the transmittance. Therefore, while realizing high display quality in the reflection display mode, visibility of an image displayed in a dark place can be assured in the transmission display mode.

According to the third aspect of the present invention, as the pattern display portion, the transparent resin sheet on which the light suppression part is formed is used. Thus, it can increase the added value at low cost.

According to the fourth aspect of the present invention, the light suppression part is formed by ink. Thus, it can further increase the added value at low cost.

According to the fifth aspect of the present invention, as the pattern display portion, the second liquid crystal panel in which the light suppression part is formed according to an applied voltage is used, so that the light suppression part can be formed in an arbitrary pattern and in an arbitrary place. Consequently, the user can change an image displayed through the second liquid crystal panel and its display position, so that the added value can be further increased. The light suppression part may not be formed. With the configuration, display/non-display of an image displayed through the second liquid crystal panel can be selected, so that an image through the second liquid crystal panel can be displayed in accordance with the intension of the user and the situation.

According to the sixth aspect of the present invention, an image of the segment form is displayed through the second liquid crystal panel. Consequently, display can be performed with a simple configuration in the case where an image to be displayed through the second liquid crystal panel is formed by alphanumeric characters.

According to the seventh aspect of the present invention, an image of the dot matrix form is displayed through the second liquid crystal panel. Consequently, an image to be displayed through the second liquid crystal panel can be displayed at high resolution.

According to the eighth aspect of the present invention, an image to be displayed through the second liquid crystal panel is displayed by the active matrix driving. Thus, since an image to be displayed through the second liquid crystal panel can be displayed at high contrast, the added value can be further increased.

According to the ninth aspect of the present invention, an image to be displayed through the second liquid crystal panel is displayed by the simple matrix driving. Thus, it can increase the added value at low cost.

According to the tenth aspect of the present invention, the second liquid crystal panel is of the transmission type and, to display an image through the second liquid crystal panel, the light source is commonly used by the first and second liquid crystal panels. In such a manner, without further requiring power of driving the light source, an image through the second liquid crystal panel can be arbitrarily displayed.

### BRIEF DESCRIPTION OF THE DRAWINGS

FIG. 1 is an exploded diagram illustrating a configuration of a display device according to a first embodiment of the present invention.

FIG. 2 is a cross-sectional view of a part corresponding to one pixel in the display device illustrated in FIG. 1.

FIG. 3 is a schematic diagram illustrating an electric configuration of a part corresponding to one pixel in a memory liquid crystal panel in the display device illustrated in FIG. 1.

FIG. 4 is an exploded perspective view of the display device of FIG. 1 which is exploded in a plane.

FIG. 5 is a plan view illustrating a display state of the display device of FIG. 1, in a transparent display mode.

FIG. 6 is an exploded perspective view of a display device according to a second embodiment of the present invention, which is exploded in a plane.

FIG. 7 is a plan view illustrating a display state of the display device of FIG. 6, in a transparent display mode.

FIG. 8 is an exploded perspective view of a display device according to a third embodiment of the present invention, which is exploded in a plane.

FIG. 9 is a plan view illustrating a display state of the display device of FIG. 8, in a transparent display mode.

### MODES FOR CARRYING OUT THE INVENTION

Hereinafter, embodiments of the present invention will be described with reference to the accompanying drawings.

### 1. First Embodiment

### 1.1 General Configuration

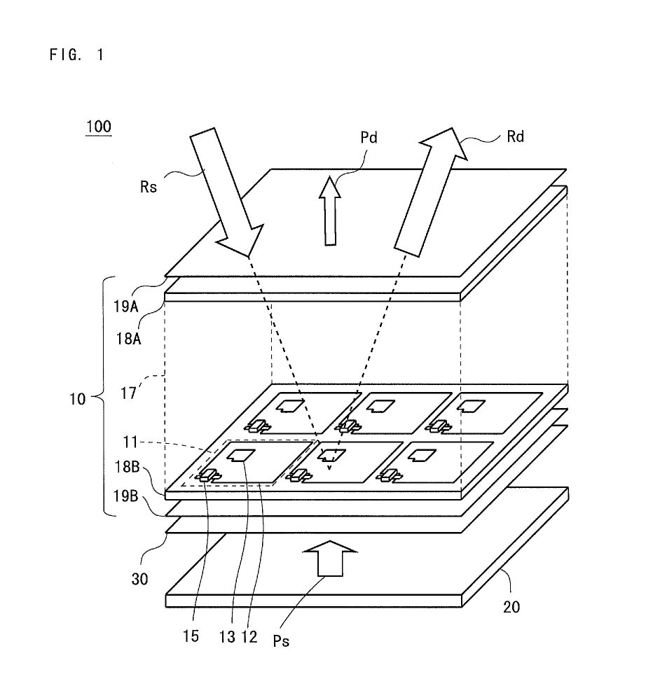

FIG. 1 is an exploded diagram illustrating a configuration of a display device according to a first embodiment of the present invention. For convenience, FIG. 1 illustrates that a display device 100 includes six pixel circuit portions 11 which will be described later. The display device 100 illustrated in FIG. 1 has a memory liquid crystal panel 10 as a first liquid crystal panel, a backlight 20 as a light source, and a PET (Poly Ethylene Terephthalate) sheet 30 as a pattern display portion.

The memory liquid crystal panel 10 includes a counter substrate 18A, an array substrate 18B, a liquid crystal layer 17 sandwiched by the substrates 18A and 18B, a plurality of gate lines GL (not illustrated) provided on a surface on the liquid crystal layer 17 side of the array substrate 18B, a plurality of source lines SL (not illustrated) provided on the surface on the liquid crystal layer 17 side of the array substrate 18B and crossing the plurality of gate lines GL, and the pixel circuit portions 11 provided at the respective crossing points of the plurality of gate lines GL and the plurality of source lines SL. On the surface on the liquid crystal layer 17 side of the counter substrate 18A, a counter electrode is provided (not illustrated). The memory liquid crystal panel 10 also includes a front polarizing film 19A provided on the side opposite to the liquid crystal layer 17 of the counter substrate 18A and a rear polarizing film 19B provided on the side opposite to the liquid crystal layer 17 of the array substrate 18B. Typically, the memory liquid crystal panel 10 also includes a gate driver for driving the gate lines GL and a source driver for driving the source lines SL (which are not illustrated).

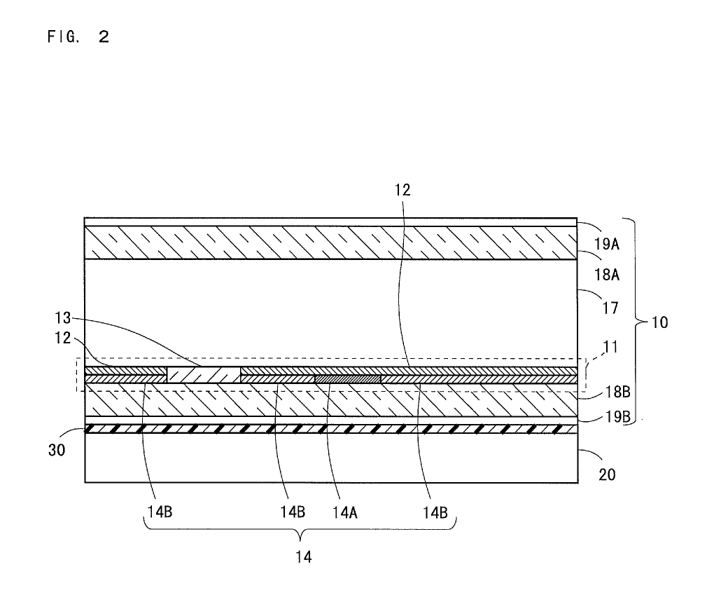

FIG. 2 is a cross-sectional view of a part corresponding to one pixel in the display device 100 illustrated in FIG. 1. As illustrated in FIGS. 1 and 2, the pixel circuit portion 11 has a reflecting electrode 12 as a reflecting portion, a transmission electrode 13 as a transmission portion, an on-substrate circuit group 14, and a TFT (Thin Film Transistor) 15. A pixel electrode includes the reflecting electrode 12 and the transmission electrode 13. The on-substrate circuit group includes a memory circuit 14A and other circuits 14B. Typically, in the other circuits 14B, a display voltage supply circuit which will be described later is formed (not illustrated). The memory circuit 14A includes, typically, an SRAM (Static Random Access Memory) capable of holding data of one bit.

As the backlight 20, for example, an LED (Light Emitting Diode), a cold cathode tube, or the like can be used. From the viewpoint of reducing the power consumption, an LED is desirable.

### 1.2 Electric Configuration and Operation of Memory Liquid Crystal Panel

FIG. 3 is a schematic diagram illustrating an electric configuration of a part corresponding to one pixel in the memory liquid crystal panel 10. The gate terminal of the TFT 15 is connected to the gate line GL, the source terminal is connected to the source line SL, and the drain terminal is connected to the memory circuit 14A. The memory circuit 14A is connected to the display voltage supply circuit. The display voltage supply circuit is connected to a black potential line and a while potential line each for supplying an analog voltage by not-illustrated means.

In the case where there is a change in an image to be displayed, display data is rewritten. At the time of rewriting display data, the gate line GL is set to a selected state to make the TFT 15 enter the conductive state, and the display data (1-bit data) is supplied from the source line SL to the memory circuit 14A. The display data already stored in the memory circuit 14A is updated, and the input display data is held in the memory circuit 14A. In the following description, display data corresponding to black display will be called “black display data” and display data corresponding to white display will be called “white display data”.

In the case where there is no change in an image to be displayed, rewriting of the display data as described above is not performed. Consequently, the display data held in the memory circuit 14A is not updated but is held as it is.

According to the display data held in the memory circuit 14A, a voltage is applied from the display voltage supply circuit to the pixel electrode. In the case where the display data held in the memory circuit 14A is black display data, the display voltage supply circuit selects a black potential line and applies a black potential to the pixel electrode. On the other hand, in the case where the display data held in the memory circuit 14A is white display data, the display voltage supply circuit selects a white potential line and applies a white potential to the pixel electrode. Since a voltage according to the display data held in the memory circuit 14A is applied between the pixel electrode and the counter electrode, an image to be displayed can be displayed. That is, the display voltage supply circuit functions as a D/A conversion circuit.

In a general active-matrix type liquid crystal display device, also in the case where there is no change in an image to be displayed, to prevent fluctuation in the potential of the pixel electrode due to leak current, data has to be written in the pixel electrode at a frequency of, for example, 60 Hz. On the other hand, in the embodiment, the black potential or white potential is always applied from the display voltage supply circuit to the pixel electrode according to the display data stored in the memory circuit 14A. That is, it is unnecessary to consider fluctuation in the potential of the pixel electrode. Therefore, as long as there is no change in an image to be displayed, data writing power is unnecessary.

Also in the embodiment, like in a general liquid display device, alternating current driving is necessary. In the embodiment, by making the black potential and the white potential displaced synchronously with the potential (counter electrode potential) applied to the counter electrode, the alternating current driving is performed. However, since the above-described data writing operation to prevent fluctuation in the potential of the pixel electrode is unnecessary, the alternating current driving can be performed at low frequency (for example, 1 Hz). The alternating current driving method is not limited to this one, and other methods may be employed.

As long as there is no change in an image to be displayed, the data writing power is unnecessary and the alternating current driving can be performed at low frequency. Therefore, power consumption of the display device 100 can be largely reduced.

### 1.3 Reflection Display Mode and Transmission Display Mode

The memory liquid crystal panel 10 in the embodiment is of the so-called micro-transmission type and the area of the transmission electrode 13 is smaller than that of the reflecting electrode 12 as illustrated in FIG. 1. In the display device 100, the “reflection display mode” of performing display by the reflecting electrode 12 using light (hereinbelow, called “outside light Rs”) incident from the front surface side (the upper side in FIG. 1) of the memory liquid crystal panel 10 is mainly used. On the other hand, the “transmission display mode” of performing display by the transmission electrode 13 using light of the backlight 20 (hereinbelow, called “backlight light Ps”) incident from the rear surface side (the lower side of FIG. 1) of the memory liquid crystal panel 10 is used secondarily. For example, the ratio of reflecting the outside light Rs (hereinbelow, called a “reflectance”) and the ratio of transmitting the backlight light Ps (hereinbelow, called a “transmittance”) of the memory liquid crystal panel 10 are set to 17% to 18% and about 0.2% to 0.3%, respectively. The ratios are not limited to the above.

In a place where the outside light Rs is strong (hereinbelow, called a “light place”), display is performed in the reflection display mode. In the reflection display mode, the backlight 20 is not driven. The outside light Rs is reflected by the reflecting electrode 12 and provided as reflected light Rd for display. Since only the outside light Rs is used in the reflection display mode as described above, display can be performed with low power consumption.

In addition, as described above, the reflectance is higher than the transmittance. The reflected light Rd of the sufficient amount contributes to display in a light place. Therefore, in the reflection display mode, high display quality can be realized.

In a place where the outside light Rs is weak (hereinbelow, called a “dark place”), display is performed in the transmission display mode. In the transmission display mode, the backlight 20 is driven and the backlight light Ps is emitted. The backlight light Ps passes through the transmission electrode 13 and is provided as transmitted light Pd for display. Since the display is performed using the backlight light Ps supplementarily in the transmission display mode as described above, visibility of a display image can be assured also in a dark place. Even in the dark place, slight outside light Rs is reflected by the reflecting electrode 12 and provided as the reflected light Rd for display.

In addition, as described above, the reflectance is higher than the transmittance. Consequently, while realizing high display quality in the reflection display mode, visibility of a display image in a dark place can be assured by the transmission display mode.

The reflection display mode and the transmission display mode may be automatically switched based on the strength of the outside light Rs or manually switched by the user. The other switching methods may be also employed.

### 1.4 Configuration of PET Sheet and Display Image

On the surface of the PET sheet 30, print patterns 32A to 32D as light suppression portions for suppressing transmission of light are formed by ink. Here, “suppressing transmission of light” means that a light transmission state in an area where the light suppression portion is formed and that in the other area are made different from each other. That is, it is not limited to complete shut-off of light but also includes reduction of light amount and shut-off of a specific wavelength.

As a method of forming the print patterns 32A to 32D, for example, ink jet printing, offset printing, or the like can be used. Note that, the pattern display portion is not limited to the PET sheet 30 but another transparent resin sheet may be employed.

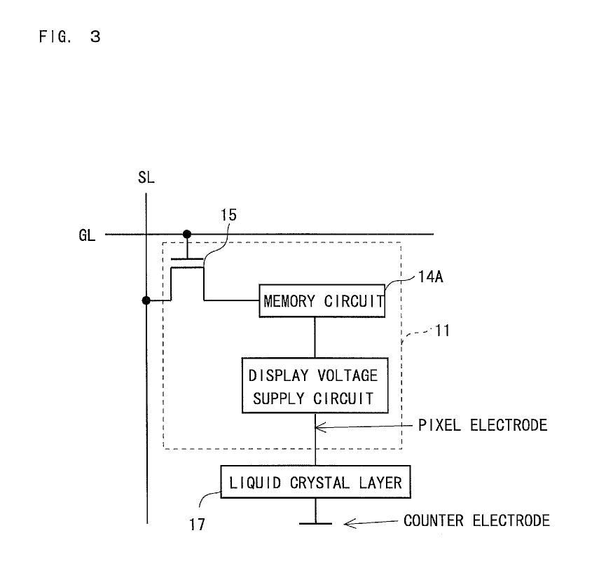

FIG. 4 is an exploded perspective view of the display device 100 which is exploded in a plane. In the transmission display mode, the region in which the print patterns 32A to 32D are printed in the PET sheet 30 suppresses transmission of the backlight light Ps. On the other hand, the region in which the print patterns 32A to 32D are not printed transmits the backlight light Ps without suppressing the light. In such a manner, by selectively suppressing transmission of the backlight light Ps, that is, by suppressing transmission of part of the backlight light Ps, an image (hereinbelow, called a “sub image Sp”) displayed through the pattern display portion (PET sheet 30) is additionally displayed on an image (hereinbelow, called a “main image Mp”) which is displayed by the memory liquid crystal panel 10. As the sub image Sp, for example, a product logo or a brand name (“LOGO” in FIG. 4) is displayed.

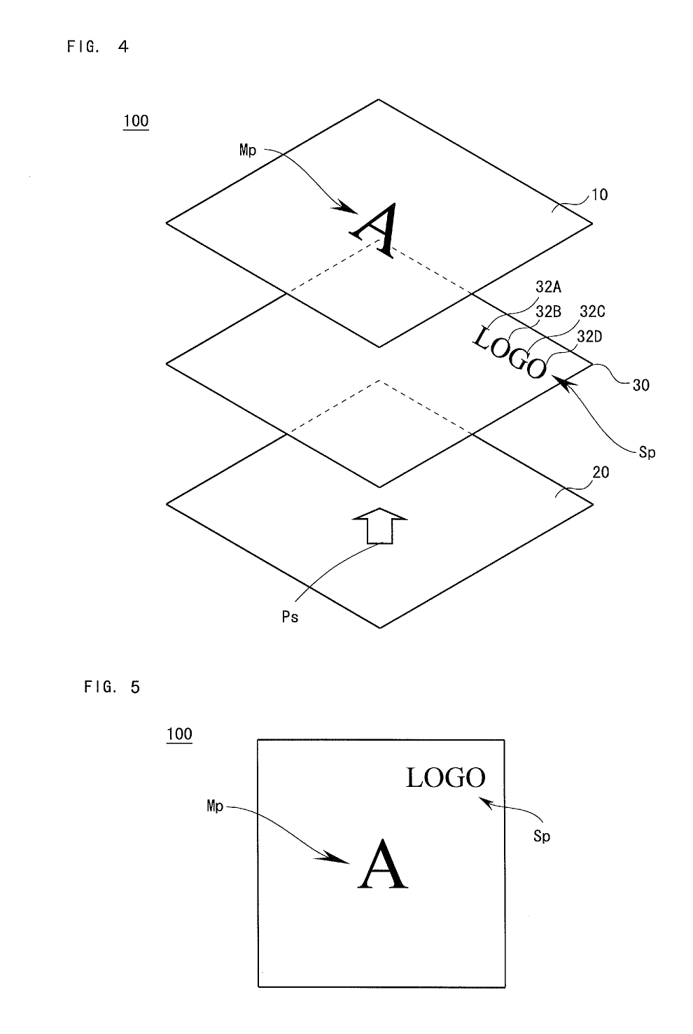

FIG. 5 is a plan view illustrating a display state of the display device 100 in the transparent display mode. As illustrated in FIG. 5, the main image Mp and the sub image Sp are displayed as a single display image.

Note that in the case of performing display in the transmission display mode in a light place, the reflected light Rd contributes to display more than the transmitted light Pd, so that the sub image Sp is hardly displayed. That is, the sub image Sp is clearly displayed only in the case of performing the display in the transmission display mode in a dark place.

On the other hand, when the backlight 20 is not driven in the reflection display mode, the backlight light Ps is not emitted. Consequently, since the PET sheet 30 does not transmit light, the sub image Sp is not displayed. In the reflection display mode, only the main image Mp is displayed regardless of the light place or the dark place.

As the ink for forming the print patterns 32A to 32D, any ink may be used as long as the transmission state of the backlight light Ps in the region in which the print patterns 32A to 32D are printed in the PET sheet 30 and that in the other region can be made different from each other. For example, the color is not limited to black but may be red, blue, yellow, or the like and may be semi-transparent color which transmits light slightly.

### 1.5 Effect

According to the embodiment as described above, as long as there is no change in an image to be displayed, data write power is unnecessary, and the alternating current driving can be performed at low frequency. Accordingly, power consumption can be reduced. In a light place, display is performed in the reflection display mode using only the outside light Rs. In such a manner, the power consumption can be further reduced. Further, in the transmission display mode supplementarily using the backlight light Ps, the sub image Sp is displayed in addition to the main image Mp. It realizes improvement in design and merchantability.

In the memory liquid crystal panel 10 in the embodiment, the reflectance is higher than the transmittance. Consequently, while realizing high display quality in the reflection display mode, visibility of a display image in a dark place can be assured by the transmission display mode.

The PET sheet 30 is used as the pattern display portion. Consequently, improvement in design and merchantability can be realized at low cost.

The print patterns 32A to 32D are formed by ink. Consequently, further improvement in design and merchantability of the display device 100 can be realized at lower cost.

### 2. Second Embodiment

### 2.1 General Configuration

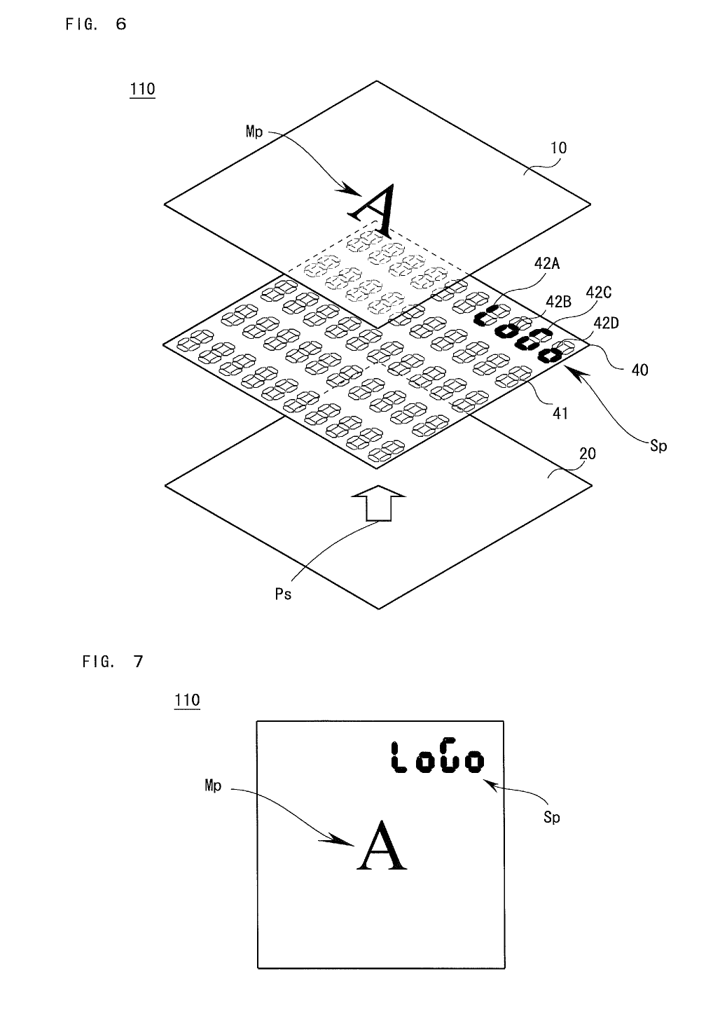

FIG. 6 is an exploded perspective view of a display device according to a second embodiment of the present invention, which is exploded in a plane. A display device 110 illustrated in FIG. 6 has a segment liquid crystal panel 40 as a second liquid crystal panel in place of the PET sheet 30. In the liquid crystal display device according to this embodiment, constituent elements which are identical with those of the liquid crystal display device 100 according to the first embodiment are denoted with the same reference symbols in the first embodiment, and the description thereof will not be given here.

### 2.2 Configuration of Segment Liquid Crystal Panel and Display Image

The segment liquid crystal panel 40 includes, typically, an array substrate, a counter substrate, a liquid crystal layer sandwiched between the array substrate and the counter substrate, a segment electrode provided on the surface on the liquid crystal layer side of the array substrate, and a common electrode provided on the surface on the liquid crystal layer side of the counter substrate (which are not illustrated). By the segment electrode, the liquid crystal layer, and the counter electrode, a plurality of segment pixel portions 41 are formed. The segment pixel portions 41 are disposed in segments. Although the segment pixel portion 41 is made by seven segments in the embodiment, the number is not limited to seven. For example, the segment pixel portion 41 may be made by 14 segments, 16 segments, or the like. Although the segment pixel portions 41 are formed in the entire surface of the segment liquid crystal panel 40 as illustrated in FIG. 6, they may be formed in a part.

The segment liquid crystal panel 40 is a transmission-type liquid crystal panel which displays an image by using the backlight light Ps.

To the outer part of the segment liquid crystal panel 40, a segment driver for applying a voltage between the segment electrode and the counter electrode is connected (not illustrated). The segment driver may be formed integrally with the segment liquid crystal panel 40. According to the voltage applied between the segment electrode and the counter electrode, each of the segment pixel portions 41 becomes segment light suppression portions 42A to 42D which suppress transmission of light. The segment light suppression portions 42A to 42D can be formed in an arbitrary pattern or in an arbitrary place by controlling the applied voltage. Further, the segment light suppression portions 42A to 42D may not be formed.

In the transmission display mode, the region in which the segment light suppression portions 42A to 42D are formed in the segment liquid crystal panel 40 suppresses transmission of the backlight light Ps. On the other hand, the region in which the segment light suppression portions 42A to 42D are not formed transmits the backlight light Ps without suppressing the light. By selectively suppressing transmission of the backlight light Ps, that is, suppressing transmission of part of the backlight light Ps in this manner, the sub image Sp is additionally displayed to the main image Mp as illustrated in FIG. 7.

Note that, it is sufficient to make the transmission state of the backlight light Ps in the region in which the segment light suppression portions 42A to 42D are formed and that in the other region different from each other. The segment light suppression portions 42A to 42D may not completely shut off the backlight light Ps. For example, the segment light suppression portions 42A to 42D may semi-transmit the backlight light Ps (indicate half tone of white and black).

### 2.3 Effect

According to the embodiment, the segment light suppression portions 42A to 42D can be formed in an arbitrary pattern and an arbitrary place. Thus, since the user can freely change the sub image Sp and its display position, further improvement in design and merchantability can be realized. The segment light suppression portions 42A to 42D may not be formed. In such a manner, display or non-display of the sub image Sp can be selected, so that the sub image Sp can be displayed according to the intension of the user and the situation.

The transmission-type segment liquid crystal panel 40 and the memory liquid crystal panel 10 commonly use the backlight 20 for displaying the sub image Sp. In such a manner, without requiring further backlight drive power, arbitrary display of the sub image Sp can be performed.

The sub image Sp is displayed in a segment form. In this way, in the case such that the sub image Sp to be displayed is formed by alphanumeric characters, it can be displayed with a simple configuration.

### 3. Third Embodiment

### 3.1 General Configuration

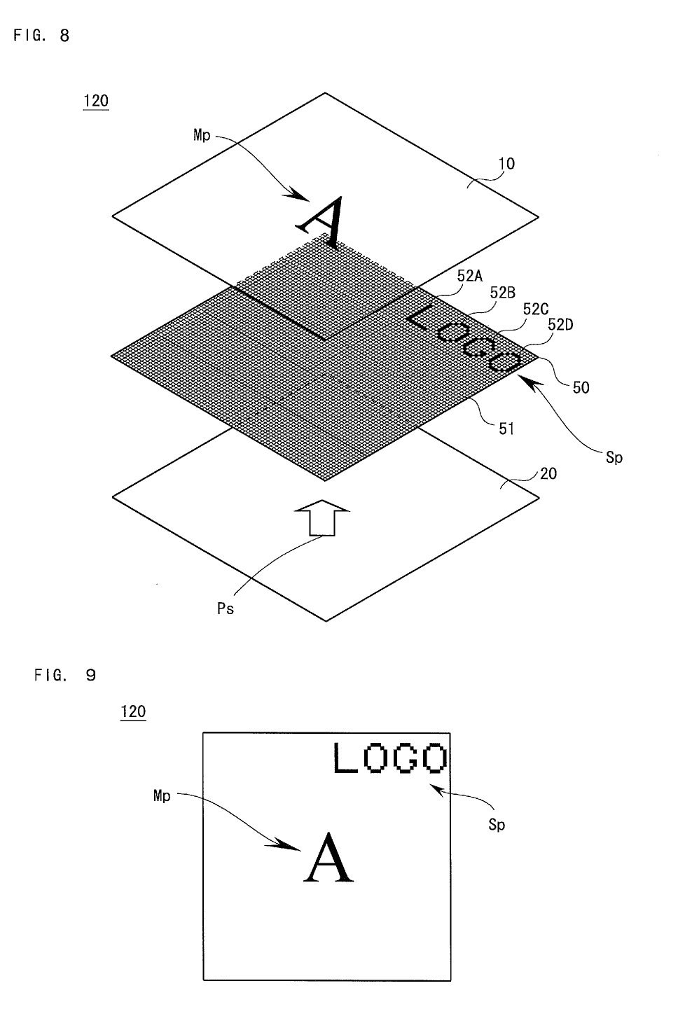

FIG. 8 is an exploded perspective view of a display device according to a third embodiment of the present invention, which is exploded in a plane. A display device 120 illustrated in FIG. 8 has, in place of the PET sheet 30, a dot matrix liquid crystal panel 50 as a second liquid crystal panel. In the liquid crystal display device according to this embodiment, constituent elements which are identical with those of the liquid crystal display device 100 according to the first embodiment are denoted with the same reference symbols in the first embodiment, and the description thereof will not be given here.

### 3.2 Configuration of Dot Matrix Liquid Crystal Panel and Display Image

The dot matrix liquid crystal panel 50 is typically of an active matrix drive type (also called a TFT drive type). Specifically, the dot matrix liquid crystal panel 50 includes an array substrate, a counter substrate, a liquid crystal layer sandwiched between the array substrate and the counter substrate, a plurality of gate lines provided on a surface on the liquid crystal layer side of the array substrate, a plurality of source lines provided on a surface on the liquid crystal layer side of the array substrate and crossing the plurality of gate lines, pixel electrodes provided at the respective crossing points of the plurality of gate lines and the source lines via TFTs, and a counter electrode provided on the surface on the liquid crystal layer side of the counter substrate (which are not illustrated). By the pixel electrode, the TFT, the liquid crystal layer, and the counter electrode, a plurality of dot matrix pixel portions 51 are formed.

The dot matrix liquid crystal panel 50 is a transmission-type liquid crystal panel which displays an image by using the backlight light Ps.

To the outer part of the dot matrix liquid crystal panel 50, a gate driver and a source driver for driving the plurality of gate lines and the plurality of source lines, respectively, are connected (not illustrated). The gate driver and the source driver may be formed integrally with the dot matrix liquid crystal panel 50. When the gate line is in a selection state, a voltage is applied from the source driver to the pixel electrode. According to the voltage applied between the pixel electrode and the counter electrode, each of the dot matrix pixel portions 51 becomes segment light suppression portions 42A to 42D which suppress transmission of light. The dot matrix light suppression portions 52A to 52D can be formed in an arbitrary pattern or in an arbitrary place by controlling the applied voltage. Further, the dot matrix light suppression portions 52A to 52D may not be formed.

In the transmission display mode, the region in which the dot matrix light suppression portions 52A to 52D are formed in the dot matrix liquid crystal panel 50 suppresses transmission of the backlight light Ps. On the other hand, the region in which the dot matrix light suppression portions 52A to 52D are not formed transmits the backlight light Ps without suppressing the light. By selectively suppressing transmission of the backlight light Ps, that is, suppressing transmission of part of the backlight light Ps in this manner, the sub image Sp is additionally displayed in the main image Mp as illustrated in FIG. 9.

Note that, it is sufficient to make the transmission state of the backlight light Ps in the region in which the dot matrix light suppression portions 52A to 52D are formed and that in the other region different from each other. The dot matrix light suppression portions 52A to 52D may not completely shut off the backlight light Ps. For example, the dot matrix light suppression portions 52A to 52D may semi-transmit the backlight light Ps (indicate half tone of white and black).

### 3.3 Effect

According to the embodiment, the dot matrix light suppression portions 52A to 52D can be formed in an arbitrary pattern and an arbitrary place. Thus, since the user can freely change the sub image Sp and its display position, further improvement in design and merchantability can be realized. Further, the dot matrix light suppression portions 52A to 52D may not be formed. In such a manner, display or non-display of the sub image Sp can be selected, so that the sub image Sp can be displayed according to the intension of the user and the situation.

The transmission-type dot matrix liquid crystal panel 50 and the memory liquid crystal panel 10 commonly use the backlight 20 for displaying the sub image Sp. In such a manner, without requiring further backlight drive power, arbitrary display of the sub image Sp can be performed.

The sub image Sp is displayed in a dot matrix form. Consequently, the sub image Sp can be displayed at high resolution.

The sub image Sp is displayed by active matrix driving. Consequently, the sub image Sp can be displayed at high contrast, so that further improvement in design and merchantability can be realized.

### 4. Others

Although each of the embodiments has been described using the 1-bit display of white and black as an example, the present invention is not limited to the example. For example, a memory circuit capable of holding data of two or larger bits may be used. Moreover, for example, a color image may be displayed using three pixel circuit portions (red, green, and yellow) as a minimum unit.

Further, the present invention can be applied to a display device of any of the normally-white type and the normally-black type.

Furthermore, each of the segment pixel portions 41 in the second embodiment and each of the dot matrix pixel portions 51 in the third embodiment may be provided with a memory circuit. In this case, power consumption can be further reduced.

In addition, in the third embodiment, the dot matrix liquid crystal panel 50 is of the active matrix driving method. However, the present invention is not limited to the above. That is, the dot matrix liquid crystal panel 50 may be of a simple matrix driving method (also called passive matrix driving method). In the case of the simple matrix driving method, typically, a liquid crystal material of the STN (Super Twisted Nematic) type is used for the liquid crystal layer. The dot matrix liquid crystal panel of the simple matrix driving method does not need a TFT for each of pixel portions, so that its manufacture cost is lower than that of the dot matrix liquid crystal panel of the active matrix driving method. Consequently, in the case where it is desired to realize a display device capable of displaying a sub image Sp of high resolution at lower cost, it is desirable to employ the dot matrix liquid crystal panel of the simple matrix driving method as a second liquid crystal panel.

In the transmission display mode, it is desirable to display the sub image Sp so as not to disturb display of the main image Mp. For example, the main image Mp and the sub image Sp are not overlapped. In this manner, without disturbing visibility of the main image Mp, improvement in design and merchantability can be realized. Here, even in the case where the main image Mp and the sub image Sp overlap, by making the sub image Sp semi-transparent (by making the light suppression portion slightly transmit the backlight light Ps), without preventing visibility of the main image Mp, improvement in design and merchantability can be realized. Moreover, regardless of the display positions of the main image Mp and the sub image Sp, by changing the tone of the light suppression portions, visibility of the main image Mp can be assured.

As described above, according to the present invention, the display device with low power consumption having increased added value can be obtained.

### INDUSTRIAL APPLICABILITY

The present invention can be applied to a display device in which each of pixels is provided with a memory function.

### DESCRIPTION OF REFERENCE CHARACTERS

10: MEMORY LIQUID CRYSTAL PANEL
11: PIXEL CIRCUIT PORTION
12: REFLECTING ELECTRODE
13: TRANSMISSION ELECTRODE
14A: MEMORY CIRCUIT
20: BACKLIGHT
30: PET SHEET
32A to 32D: PRINT PATTERN
40: SEGMENT LIQUID CRYSTAL PANEL
41: SEGMENT PIXEL PORTION
42A to 42D: SEGMENT LIGHT SUPPRESSION PORTION
50: DOT MATRIX LIQUID CRYSTAL PANEL
51: DOT MATRIX PIXEL PORTION
52A to 52D: DOT MATRIX LIGHT SUPPRESSION PORTION
100, 110, 120: DISPLAY DEVICE
Ps: BACKLIGHT LIGHT
Mp: MAIN IMAGE
Sp: SUB IMAGE

1. A display device for performing display in a reflection display mode and a transmission display mode, comprising:
a first liquid crystal panel including a plurality of pixel circuit parts each having a reflector, a transmitter, and a memory circuit capable of holding at least 1-bit data;
a light source provided on a rear surface side of the first liquid crystal panel; and
a pattern display portion provided between the first liquid crystal panel and the light source and selectively suppressing transmission of light from the light source,
wherein in the reflection display mode, display is performed using light incident from a front surface side of the first liquid crystal panel and,
in the transmission display mode, display is performed using light of the light source incident from the rear surface side of the first liquid crystal panel.

2. The display device according to claim 1, wherein in the first liquid crystal panel, the ratio of reflecting light incident from the front surface side of the first liquid crystal panel is higher than the ratio of transmitting light of the light source which is incident from the rear surface side of the first liquid crystal panel.

3. The display device according to claim 1, wherein the pattern display portion is a transparent resin sheet on which a light suppression part for suppressing transmission of light is formed.

4. The display device according to claim 3, wherein the light suppression part is formed by ink.

5. The display device according to claim 1, wherein the pattern display portion is a second liquid crystal panel in which a light suppression part for suppressing transmission of light is formed according to an applied voltage.

6. The display device according to claim 5, wherein the second liquid crystal panel is of a segment display type.

7. The display device according to claim 5, wherein the second liquid crystal panel is of a dot matrix display type.

8. The display device according to claim 7, wherein the second liquid crystal panel is of an active matrix drive type.

9. The display device according to claim 7, wherein the second liquid crystal panel is of a simple matrix drive type.

10. The display device according to claim 5, wherein the second liquid crystal panel is of a transmission type.
